(19) United States
(12) Patent Application Publication
(10) Pub. No.: US 2007/0005250 A1
(43) Pub. Date: Jan. 4, 2007

(54) System and method for locating leaks in petroleum wells

(75) Inventor: Vicente Gonzalez Davila, Tamps, MX (US)

Correspondence Address: Miguel Villarreal, Jr.;Suite 1500, 700 N. St. Mary's Street, San Antonio, TX, 78205, US

(73) Assignee: Geo Estratos, S.A. de C.V.

(21) Appl. No.: 11/167,656

(22) Filed: Jun. 27, 2005

(51) Int. Cl. G01V 1/40

(52) U.S. Cl. 702/6

(57) ABSTRACT

A system and method for locating leaks in oil wells based on the principles of vibration and pressure. Leaks are located by the identification and measurement of characteristic signals comprising elastic mechanical vibrations and pressure activity within the interior of an oil well that corresponds to the depth and location of leaks. For multiple leak determinations, a separate parallel well is drilled a short distance from the target oil well. The parallel well is filled with water and the studies are conducted within this parallel well, such information correlating to the conditions of the target oil well.

### BACKGROUND OF THE INVENTION

1. Field of The Invention

Applicant's invention relates to the field of crude oil production and more specifically to a system and method for locating leaks in petroleum wells through the use and measurements of elastic mechanical vibrations and pressure activity within the oil well's interior. The phrases “petroleum well” and “oil well” are used synonymously throughout this application.

2. Background Information

Historically, migration of crude oil through cracks and fractures of rocks have always existed. It is through these cracks and fractures that crude oil makes its way to the ground surface. Generally, oil wells are constructed using steel piping. Steel piping is susceptible to oxidation and corrosion which may cause the oil well to leak its contents through the casing. This uncontrolled leaking of hydrocarbons and gases from the oil well eventually surfaces at ground level, affecting surface and underground water and soil throughout their migration to the surface. This makes for an unsightly accumulation of crude oil on the ground surface. Further, throughout its path of migration, the crude oil adversely affects underground water and soil, and natural wildlife. This creates a negative environmental impact. The present invention provides for a system and method to locate leaks in an oil well quickly and efficiently, minimizing or eliminating these adverse effects.

There exists in the prior art several related patents. U.S. Pat. No. 3,776,032 discloses protection of an inflow of either gas or liquid into a well. The detection occurs during the drilling of the well for the prevention of blowouts. The detection process involves the use of pressure mud pulses from a pair of acoustical transducers, which generate signals in the form of pressure waves, both before the drilling mud is circulated to the drill bit and after drilling mud is circulated through the drill bit. The difference, if any, in the two signals are then converted to a signal then transmitted to the surface.

U.S. Pat. No. 4,114,721 discloses a pair of acoustic detectors moving through a well to detect sound which is indicative of a through casing leak, i.e., a leak that goes through the casing. The acoustic noise generated by the noise sources is monitored at two spaced-apart locations within the borehole. The signals, representing the monitored acoustic noise at each location, are transmitted uphole.

U.S. Pat. No. 4,101,827 discloses the detection of leaks in an underground pipe which is made of electrically insulating material, i.e., material that does not conduct electricity. The detection process involves partially filling the pipe with an electrically conductive fluid, such as tap water, passing an electrical current through the fluid to establish a voltage gradient along the length of the fluid in the pipe, and then analyzing the gradient to determine the location of the leak. The voltage source is electronically connected to one electrode which is immersed in the liquid at one pipe end, and to a second electrode which is driven into the ground. The method disclosed in this patent involves inserting a wire inside the underground pipe in order to properly determine the potential drop and the determination of the location of the leak or leaks is done by measuring the length of wire inserted into the underground pipe at the point where there is a potential drop, i.e., the point of minimal voltage.

U.S. Pat. No. 5,548,530 discloses a non-intrusive high-precision ultra-sonic leak detector system for pipelines for identification of the development of even very minute, i.e., millimeter size, leaks and locates them within several meters of their actual location in a segment between two site stations of the overall leak detection. Leaks are located and their locations determined by their effect on the pressure of the pipeline, and the effect of the pressure change on liquid density.

U.S. Pat. No. 6,442,999 discloses the same technology that is disclosed in U.S. Pat. No. 5,548,530 regarding detection of leaks in an underground pipeline system. However, U.S. Pat. No. 6,442,999 adds a master station to which site stations transmit sonic wave data in order to perform calculations to determine the presence of a leak and also their location.

U.S. Pat. No. 6,530,263 discloses a system for finding and locating leaks in a pipeline using loggers positioned along the pipeline at spaced intervals. These loggers detect and store sound data produced within the pipeline and download the stored sound data to a computer system to determine the location of the leaks.

U.S. Pat. No. 6,595,038 discloses an apparatus for determining the position of a leak in an underground pipe for fluid or gas using two acoustic sensors. The first sensor is coupled to the pipe while the second sensor is movable above the pipe. Both sensors detect sound either carried along the walls of the pipe or along fluid in the pipe.

U.S. Pat. No. 6,668,619 discloses a method and apparatus for locating the source of a leak in a pipeline using match pattern filtering techniques. These match pattern filters discriminate against background noise and pressure disturbances generated by other non-leak sources. This method uses acoustic signals to determine whether a leak exists and where it is located.

Finally, U.S. Pat. No. 6,650,125 discloses locating leaks of conductive fluids, such as ionized water, from non-conductive structures, such as pipes, through the use of a charge generator employed to charge and discharge the conductive fluid, and a capacitive type detector that can detect the variable charge that is induced in the fluid. This detector is handheld and portable.

The current art does not disclose locating leak(s) of crude oil in petroleum wells that are simple, inexpensive, and accurate. A need therefore exists for a cost efficient system and method for locating crude oil leaks in oil wells.

### SUMMARY OF THE INVENTION

It is an object of the present invention to provide a simple method of locating leaks.

It is another object of the present invention to provide a simple method of locating leaks in petroleum wells.

It is another object of the present invention to detect leaks in oil wells based on the measurements of vibrational and pressure activity within the oil well's interior through the use of sensors and commercially available equipment.

It is another object of the present invention to eliminate environmental concerns such as contamination of surface and underground water and soil.

It is another object of the present invention to eliminate environmental concerns such as endangering wildlife.

It is another object of the present invention to avoid crude oil accumulations at the surface.

It is another object of the present invention to increase public awareness of the negative environmental impact uncontrolled oil leaks pose.

It is another object of the present invention to create an accurate method of leak detection.

It is another object of the present invention to decrease the risk of false positives associated with other leak detection methods.

It is another object of the present invention to reduce dangerous conditions caused by accumulation of crude oil.

In satisfaction of these related objectives, Applicant's present invention provides a system and method of locating leaks in oil wells using identification of signal and wave travel times, and the measurement of vibrational and pressure activity within the oil well's interior, employing sensors and equipment which are commercially available.

The present detection system and method utilizes the principles of vibration and pressure. When a leak occurs, the flow of crude oil from the oil well produces elastic mechanical vibrations. These vibrations are generated when the well's regulation valve is closed. The vibrations travel distally from the leak toward both extremes of the oil well. The distance these vibrations travel, i.e., travel time, gives information useful in ascertaining how far down the oil well the leak is located. To obtain this information, a measurement of the travel time of these elastic mechanical vibration signals or waves, from the leak to the top of the well, is necessary.

Determination of the travel time begins by installing a sensor in the well below the oil well's regulation valve. The sensor receives the vibrational signals or waves from the oil well's interior. This vibration sensor is connected to, and sends detected vibrational activity to, a highly sensitive detection device. This highly sensitive detection device measures the elastic mechanical vibrations, sending the measurement signals through a cable to a data acquisition card on the ground surface. Although a cable is used in the present invention for the transmission of data, it is recognized that the capabilities of wireless data transfer exist. The present invention contemplates and includes such wireless transmissions into this application.

A second sensor, a digital pressure meter, is connected to the oil well between the ground surface and the vibration sensor. This location is also below the well's regulation valve. The digital pressure meter measures the pressure activity within the interior of the oil well and permits identification of the highest pressure achieved when the well's regulation valve is closed. The information collected is sent to the data acquisition card through a conduction cable.

To determine the depth of the leak, the data acquisition card produces a graphical representation of the acoustic vibrations. The graphical representation corresponding to the pressure activity is generated during the process of closing the well. This pressure curve identifies the highest pressure point. This highest pressure point corresponds to, and identifies, the start time of the elastic mechanical vibrations signal given from the leak to the elastic mechanical vibration sensor. The highly sensitive detection device determines the depth based on the travel time of the characteristic wave.

In the event where the interior of an oil well does not exert a significant pressure, i.e., less than 300 psi, or where there are two or more leaks, an alternative embodiment of the present invention may be used. In such a case, a parallel well is drilled approximately two (2) meters in distance away from the targeted oil well. The parallel well has a diameter of thirty (30) centimeters and a depth of two-hundred (200) meters. The parallel well is subsequently filled with water. The water acts as a conductor of the acoustic waves that will be detected. An elastic mechanical vibration sensor is lowered into the interior of the parallel well. The elastic mechanical vibration sensor is held by a cable which runs through a pulley system. The pulley is suspended above the oil well's borehole by a tripod. The elastic mechanical vibration sensor then detects elastic mechanical vibrations and sends these signals to a data acquisition card located at the surface. The signal travels through a cable which is connected to a wench. The adjustment of the wench controls the movement of the elastic mechanical vibration sensor within the interior of the parallel well.

The process of data acquisition commences with the closure of the oil well's regulation valve. In this way, the mechanical vibrations intensity given by the leak is maximized. The closer the elastic mechanical vibration sensor gets to the leak, the more intense the signal. This effect is illustrated as the data acquisition card processes the information, resulting in the elimination of undesired signals, or false positives. These false positives are signals whose frequency is distinct from the frequency of the elastic mechanical vibrations produced by the leaks. The resulting data is displayed in a graphical representation.

Interpretation of the graphical representation resulting from the processing of this information entails the identification of detected waves or peaks of maximum amplitude juxtaposed with their adjacent waves or peaks of minimum amplitude. The number of leaks in the oil well corresponds to the number of peaks present in the graphical representation. The depth of each leak is given by the waves or peaks of maximum amplitude as displayed on the graphical representation.

Oil leaks will always migrate toward the surface of the soil due to the atmosphere having less pressure. The elastic mechanical vibration sensor will continue to register vibrational activity as long as leaks are present. When the elastic mechanical vibration sensor no longer registers a measurement of a signal or wave with the characteristic ascending tendencies within the deepest portion of the parallel well, then all of the leaks in the oil well have been detected. In the event that signals or waves with ascending tendencies are still being detected, it would be necessary to deepen the parallel well and reinitiate the process.

### BRIEF DESCRIPTION OF THE DRAWINGS

FIG. 1 is an elevation perspective view of an oil well with a leak.

FIG. 2 is an elevation view of the preferred embodiment of the present invention illustrating the measurement principle for detecting an oil leak.

FIG. 3 is a graphical representation of the elastic mechanical vibrations.

FIG. 4 is a graphical representation of the pressure activity in the oil well while the well's regulation valve is closed.

FIG. 5 is an elevation view of an alternative embodiment of the present invention for detection of leaks.

FIG. 6 is an actual graphical representation produced during the use of the present invention.

### DETAILED DESCRIPTION OF THE PREFERRED EMBODIMENT

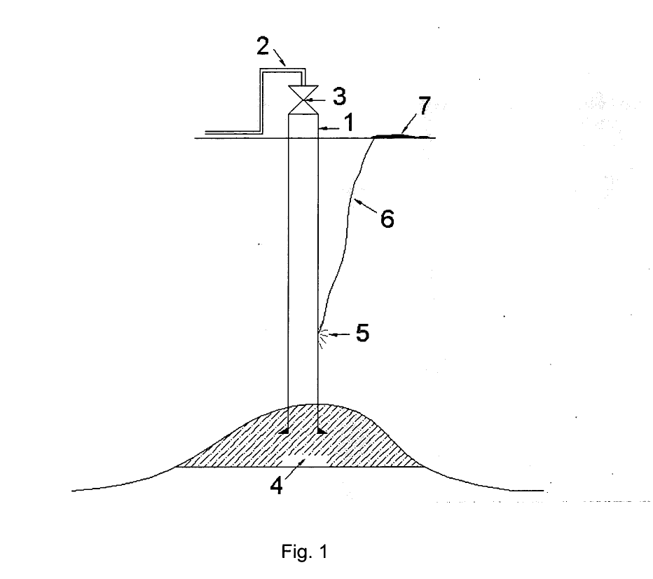

Referring to FIG. 1, crude oil path of migration 6 through cracks and fractures of rocks has always existed. It is through these cracks and fractures from which crude oil makes its way from the crude oil bed 4 to the ground surface. In cases where there is an existing oil well 1, oxidation and corrosion can lead to the deterioration of the steel piping. This deterioration results in crude oil leaks 5 through the well's casing. Now uncontained, the free-flowing crude oil traverses its path of migration 6 to the surface via cracks and fractures in the rock. This make for an unsightly accumulation of crude oil 7 on the ground surface. Further, throughout its path of migration 6, the crude oil can adversely affect underground water and soil, and natural wildlife.

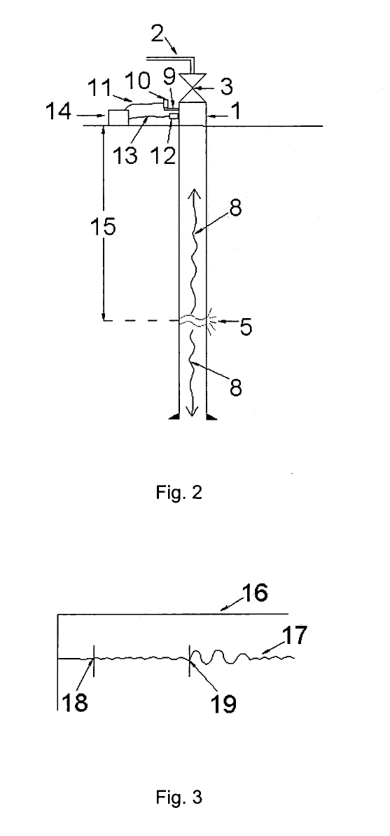

The preferred embodiment of the present invention is illustrated in FIG. 2. FIG. 2 is an elevation view of the preferred embodiment of the present invention illustrating the measurement principle for detecting an oil leak 5 in an oil well 1. The detection method utilizes the principles of vibration and pressure. When a leak 5 occurs, the flow of crude oil from the oil well 1 produces elastic mechanical vibrations 8 originating from the leak 5. These elastic mechanical vibrations 8 are generated when the well's regulation valve 3 is closed. The elastic mechanical vibrations 8 travel distally from the leak 5 toward both extremes of the oil well 1. The distance these vibrations travel, i.e., travel time, gives information useful in ascertaining how far down the oil well 1 the leak 5 is located. To obtain this information, a measurement of the travel time of these elastic mechanical vibrations 8, from the leak 5 to the top of the oil well 1, is necessary.

Still referring to FIG. 2, determination of the travel time begins by installing a vibration sensor 9 in the oil well 1. The sensor 9 is connected to a highly sensitive detection device 10. This highly sensitive detection device 10 measures the elastic mechanical vibrations 8, sending the measurement signals to a data acquisition card 14 on the ground surface through a cable 11.

A digital pressure meter 12 is connected to the oil well 1 between the ground surface and the vibration sensor 9. The digital pressure meter 12 measures the pressure activity within the interior of the oil well 1 and permits identification of the highest pressure achieved when the well's regulation valve 3 is closed. The information is subsequently transmitted to the data acquisition card 14 via a conduction cable 13.

Once this detection system is installed, the acquisition of vibration and pressure data initiates while the well's regulation valve 3 is in an open position. The well's regulation valve 3 is then closed in order to allow pressure to build within the oil well 1. The build up of pressure allows the leak 5 to achieve it highest pressure. The acoustic signal's amplitude and intensity produced by the leak 5 is directly proportional to the pressure.

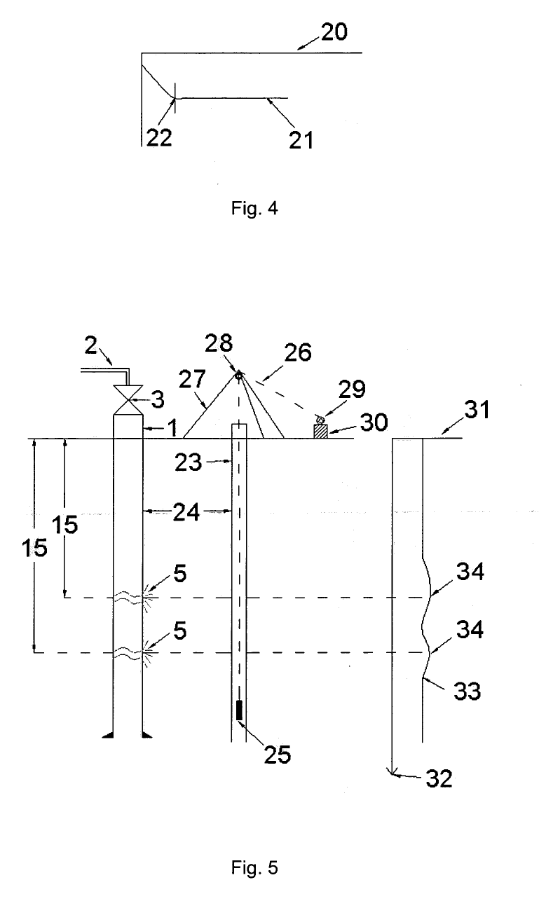

To determine the depth 15 of the leak 5, the data acquisition card 14 produces a graphical representation 16 of acoustic waves 17, as illustrated in FIG. 3. Referring to FIG. 3, the start time 18 of the acoustic wave 17 is defined by the highest intensity produced at the moment of closure of the oil well's regulation valve 3. The corresponding graphical representation 20 of the pressure activity is also generated during the process of closing the oil well's regulation valve 3, as depicted in FIG. 4. This pressure curve identifies the highest pressure point 22. The start time 18 is identified in the pressure graphical representation 20 (See FIG. 4) which is obtained by the digital pressure meter 12. Referring now to FIGS. 3 and 4, the highest pressure point 22 corresponds to, and identifies, the start time 18 of the acoustic wave 17 given from the leak 5 to the vibration sensor 9.

The highly sensitive detection device 10 determines the depth 15 based on the travel time of the characteristic acoustic wave 17 propagated by the elastic mechanical vibrations 8. The travel time is the difference between the initial time travel of the acoustical waves toward the surface and the arrival time of the first wave of maximum amplitude measured by the highly sensitive detection device 10. The value of the initial travel time of the acoustical waves is obtained from the graphical representation 20 of pressure activity registered from the closing of the oil well's regulation valve 3.

Referring now to FIG. 6, this figure depicts an example of an actual graphical representation 35 produced during the use of the present invention. In this graphical representation 35 can be seen that the voltage range covered is from between 35 Hz to 55 Hz, the oil well 1 measuring approximately 50 meters. The y-axis 36 represents the strength of the signal in volts (V) and is labeled accordingly. The x-axis 37 represents the depth 15 in meters (m) and again is labeled accordingly. The determined leak point 38 in this example is given as being just less than 15 meters.

Once the depth is determined, the travel time is multiplied by the velocity of propagation of elastic waves for steel pipes, such velocity obtained through established literature in the art. The velocity value is characteristic of and corresponds to the steel pipes present in the oil well 1. In case more than two waves of maximum amplitude are received, the alternate procedure for detection of two or more leaks, as described hereinbelow, is used.

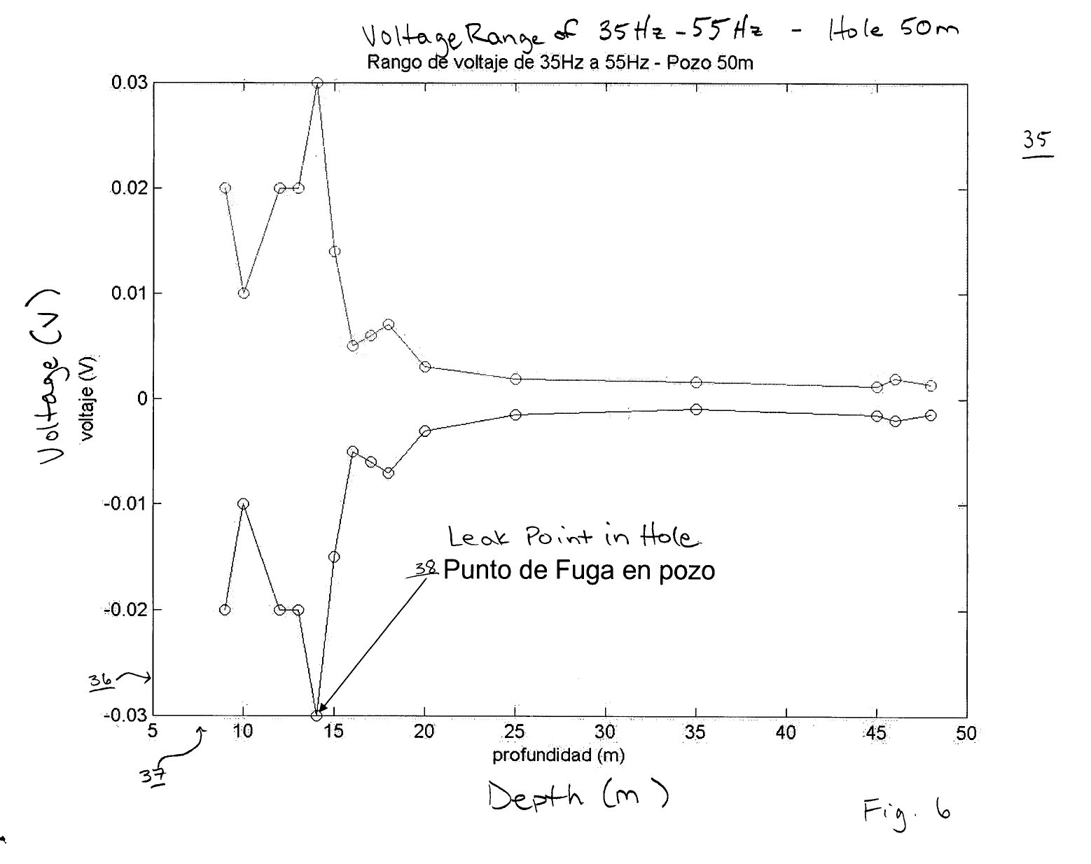

When there does not exist a significant pressure (less than 300 psi) in the interior of the oil well 1, or where there are two or more leaks, an alternative procedure can be used. Referring now to an alternative embodiment of the present invention, as illustrated in FIG. 5, a parallel well 23 is constructed at a distance 24 of two (2) meters from the original oil well 1. The borehole diameter of the parallel well 23 is thirty (30) centimeters. The parallel well 23 is constructed to a depth of 200 meters. Water is then poured into the parallel well 23 and acts as a conductor of the acoustic wave in the interior of said parallel well 23 to be detected. A tripod 27 is positioned over the parallel well 23 and supports a pulley 28. An elastic mechanical vibration sensor 25 is then lowered into the interior of the parallel well 23. The elastic mechanical vibration sensor 25 sends the measured signal to a data acquisition card 30 placed at the surface via a connection cable 26 located in a wench 29. The wench 29 controls the displacement of the elastic mechanical vibration sensor 25 within the interior of the parallel well 23.

The data acquisition process begins with the closing of the well's regulation valve 3. This maximizes the intensity of the elastic mechanical vibrations 8 wave produced by the leak 5 so that when the elastic mechanical vibration sensor 25 is nearest to the leak 5, the waves detected reach their maximum amplitude. These detected elastic mechanical vibrations 8 are then transmitted through a connection cable 26 to the data acquisition card 30 for processing and interpretation.

Signals whose origin is distinct from low frequency elastic mechanical vibrations 8 produced by the leaks 5 are discarded during the processing of the signals on the data acquisition card 30. This eliminates false positives from occurring. To determine the presence of leaks 5, a graph 33 is generated from the processed information in which the x-axis 31 represents the intensity of the signal and the y-axis 32, the corresponding depth 15. The identification of each leak 5 corresponds to each point of highest intensity signal 34 relative to its adjacent minimal signals. The interpretation of the graph 33 therefore identifies not only the number of leaks 5 present in the oil well 1, but also the depth 15, such depth 15 corresponding to the points of highest intensity signal 34 detected.

The leaks 5 will always migrate toward the surface of the soil due to the atmosphere having less pressure. The elastic mechanical vibration sensor 25 will continue to register amplitude waves as long as leaks 5 are present. When the elastic mechanical vibration sensor 25 no longer registers a measurement of waves with ascending tendencies in the deepest part of the parallel well 23, then all of the leaks 5 in the oil well 1 have been detected. In the event that waves with ascending tendencies are still being detected, it will be necessary to deepen the parallel well 23 and to reinitiate the process of acquisition, processing and interpretation of signals in the interior in the parallel well 23.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method of locating a leak in an oil well comprising the steps of:
locating an oil well with a leak;
installing a detection system onto a portion of said oil well above ground level, but below a regulation valve for said oil well, said detection system used to locate said leak;
first receiving vibrational signals produced within said oil well;
detecting said vibrational signals with a highly sensitive detection device;
second receiving pressure activity signals produced within said oil well;
transmitting said vibrational signals and pressure activity signals to a signal transducer;
converting said vibrational signals and pressure activity signals for display; and
interpreting said display.

2. The method of locating a leak in an oil well of claim 1 wherein said installing step comprises installing a first sensor connected to a highly sensitive detection device, said highly sensitive detection device connected to a first entrance of said signal transducer.

3. The method of locating a leak in an oil well of claim 2 wherein said installing step further comprises installing a second sensor connected to a second entrance of said signal transducer.

4. The method of locating a leak in an oil well of claim 3 wherein said detecting step further comprising closing of said regulation valve of said oil well.

5. The method of locating a leak in an oil well of claim 4 wherein said detecting step further comprises measuring said vibrational signals for determination of a travel time of said vibrational signals.

6. The method of locating a leak in an oil well of claim 5 wherein said detecting step further comprises measuring said pressure activity signals for determination of a start time for said vibrational signals.

7. The method of locating a leak in an oil well of claim 6 wherein said converting step further comprises displaying said vibrational signals and said pressure activity signals for interpretation by a user to determine the location of a leak in said oil well.

8. The method of locating a plurality of leaks in an oil well comprising the steps of:
drilling a parallel well adjacent to said oil well;
pouring water into said parallel well;
lowering a sensor into said parallel well, said sensor used to detect vibrational signals from within the interior of said parallel well upon the closing of a regulation valve on said oil well;
transmitting said vibrational signals to a signal transducer;
converting said signals for display; and
interpreting said display.

9. An apparatus for locating leaks in an oil well comprising:
a detection system having two receivers whereby a first receiver and a second receiver are positioned and adhered to a portion of an oil well above ground level, but below a regulation valve for said oil well;
a transmitter connected to said first receiver; and
a signal transducer connected to said transmitter and said second receiver.

10. An apparatus for locating leaks in an oil well as in claim 9 wherein said first receiver receives vibrational signals and said second receiver receives pressure activity signals.

11. An apparatus for locating leaks in an oil well as in claim 10 wherein said transmitter is a highly sensitive detection device.

12. An apparatus for locating leaks in an oil well as in claim 11 wherein said highly sensitive detection device connects to a first entrance of said signal transducer and second receiver connects to second entrance of said signal transducer.

13. An apparatus for locating leaks in an oil well as in claim 12 wherein said signal transducer is a data acquisition card.
